(19) United States
(12) Patent Application Publication
(10) Pub. No.: US 2026/0269096 A1
(43) Pub. Date: Sep. 10, 2026

(54) METHODS OF FORMING RADIOACTIVE ARTICLES AND RELATED RADIOACTIVE ARTICLES

(71) Applicant: Battelle Energy Alliance, LLC, Idaho Falls, ID (US)

(72) Inventors: Nicholas R. Mann, Idaho Falls, ID (US); Shad T. Keele, Shelley, ID (US)

(21) Appl. No.: 19/562,585

(22) Filed: Mar. 10, 2026

Related U.S. Application Data
(60) Provisional application No. 63/769,627, filed on Mar. 10, 2025.

(51) Int. Cl. G21F 9/30; B33Y 10/00; B33Y 80/00; G21G 1/00; G21G 1/06; G21G 4/02; G21H 5/00

(52) U.S. Cl. CPC G21F 9/305; B33Y 10/00; B33Y 80/00; G21G 1/001; G21G 1/06; G21G 4/02; G21H 5/00

(57) ABSTRACT

Radioactive articles including one or more isotope fragments distributed in a substrate material are disclosed. The substrate material includes a thermoplastic polymer, a fused metal powder, a fused polymer powder, or a ceramic material. Methods of forming the radioactive articles utilizing additive manufacturing processes such as material extrusion and powder bed fusion are also disclosed.

### CROSS-REFERENCE TO RELATED APPLICATIONS

This application claims the benefit under 35 U.S.C. § 119(e) of U.S. Provisional Patent Application Ser. No. 63/769,627, filed Mar. 10, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to articles and methods of forming articles containing radioactive isotopes.

### BACKGROUND

The emergency response community trains to be prepared for disaster situations, such as those that might involve the dispersal of radioactive material. To maintain preparedness, emergency response agencies conduct regular training exercises in controlled contamination environments. However, training with actual, dispersed radioactive materials (e.g., materials including radioactive isotopes such as Cs-137, Sr-90, U-235, or Ir-192) is generally problematic due to the biological and environmental radio-toxicity of these materials.

In some environments, such as indoor facilities, radioactive isotopes such as technetium-99m (Tc-99m) (^{99m}Tc) and gallium-68 (Ga-68) (⁶⁸Ga) may be used and distributed—as surrogates for other radioactive isotopes—to create the controlled contamination environment. In outdoor training environments, these or other surrogate materials, such as copper-64 (Cu-64) (⁶⁴Cu) and/or potassium bromide (K-42 and Br-82) (⁴²K and ⁸²Br), may be dispersed.

Conventionally, surrogate isotopes are dispersed within a training environment by spraying a liquid solution that includes the surrogate isotopes. Such spray-applied surrogate solutions have limitations as to areas of use and as to removable contamination amounts. The availability of the surrogate isotope materials is also limited. Moreover, once sprayed, the liquid solutions tend to become absorbed into soils and other porous surfaces, which can prohibit accurate sampling and detection of solely the source material. Due to short half-lives of the surrogate isotopes (e.g., 1 hour to 6 hours), multiple spray applications of the solution may be used throughout a training evolution to provide trainees an adequate contamination dose rate. Also, once sprayed, the surrogate solution cannot be easily retrieved and redistributed in another training facility. Often, the production and use of these short half-life surrogate isotope solutions costs thousands of US dollars.

Accordingly, developing materials and methods suitable for safely and economically simulating radioactive contamination environments continues to present challenges.

### BRIEF SUMMARY

A method of forming a radioactive article is disclosed. The method includes providing a printing material including one or more isotope fragments distributed in a substrate material, and forming, using an additive manufacturing device, the printing material into a radioactive article that includes the one or more isotope fragments distributed in the substrate material.

In another aspect, a method of forming a radioactive article is disclosed. The method includes providing a printing material including a reactant material distributed in a substrate material, forming, using an additive manufacturing device, layers of the printing material to form an unactivated article including the reactant material distributed in the substrate material, and irradiating at least a portion of the unactivated article to convert at least a portion of the reactant material into a radioactive isotope material to form the radioactive article including the radioactive isotope material dispersed in the substrate material.

Also disclosed is a radioactive article that includes one or more isotope fragments distributed in a substrate material. The substrate material includes a thermoplastic polymer, a fused metal powder, a fused polymer powder, or a ceramic material.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 illustrates a radioactive article in accordance with embodiments of the disclosure;

FIG. 2 illustrates a material of the radioactive article in accordance with embodiments of the disclosure;

FIG. 3A illustrates a matrix-embedded particle in accordance with embodiments of the disclosure;

FIG. 3B illustrates a non-embedded particle in accordance with embodiments of the disclosure;

FIG. 4 illustrates a method of forming a radioactive article in accordance with embodiments of the disclosure;

FIG. 5 illustrates a method of forming a radioactive article in accordance with embodiments of the disclosure;

FIG. 6 illustrates radioactive articles in a training venue in accordance with embodiments of the disclosure;

FIG. 7 is a graph of the gamma spectrum of a non-impregnated sample in accordance with embodiments of the disclosure;

FIG. 8A is a graph of the gamma spectrum of an impregnated sample in accordance with embodiments of the disclosure;

FIG. 8B is a graph of the gamma spectrum of an impregnated sample in accordance with embodiments of the disclosure; and

FIG. 9 is a graph of an argon atmosphere thermogravimetric analysis of a particle in accordance with embodiments of the disclosure.

### DETAILED DESCRIPTION

The illustrations presented herein are not actual views of any radioactive articles, or any component thereof, but are merely idealized representations, which are employed to describe embodiments of the invention.

As used herein, the term “particle” means and refers to a solid mass with a maximum diameter within a range from about one micron (about 1 μm) to about one centimeter (about 1 cm). Accordingly, the particles, in accordance with embodiments of the disclosure, may not be characterized as “nanoparticles.”

As used herein, the term “fragment” means and refers to a solid mass that includes at least one particle.

As used herein, the term “matrix-embedded” means and refers to a configuration or structure in which at least one particle is at least partially or wholly surrounded, retained, or immobilized by a surrounding matrix material (e.g., glass, such as high-purity silica glass). In certain embodiments, the matrix material and the particle(s) may be co-synthesized—such as via a sol-gel technique—to form a composite structure including the particle(s) dispersed throughout and embedded within the matrix material.

As used herein, the term “surrogate,” when referring to an isotope or material, means and includes an isotope or material that exhibits the same or substantially similar particular characteristics compared to those particular characteristics exhibited by an isotope or material to be emulated, i.e., by an “emulated” isotope or “emulated” material. Not all characteristics may be exhibited in the same or a similar manner. For example, it is expected that a “surrogate” isotope exhibits a shorter half-life compared to that exhibited by the emulated isotope.

As used herein, the term “high-purity,” when referring to a material, refers to that material including at about least 99 at. % (e.g., at about least 99.9 at. %, at least about 99.99 at. %) of the isotope(s), element(s), or compound(s) in question.

As used herein, the term “reactant material” refers to a precursor material to be subjected to irradiation to form an irradiated material.

As used herein, the term “matrix-embedded particle” refers to one or more irradiated particles embedded in a matrix material.

As used herein, the term “non-embedded particle” refers to an irradiated particle that is not embedded in a matrix material.

As used herein, the term “isotope fragment” refers to a radioactive isotope material in the form of a matrix-embedded particle or a non-embedded particle and that is dispersed in a substrate material.

As used herein, the term “moderate half-life” means and refers to a half-life within a range of from about one year to about thirty years.

As used herein, the term “short half-life” means and refers to a half-life within a range of from about 1 hour to about 1 year.

As used herein, the term “ceramic material” means and refers to an inorganic, nonmetallic material that may be formed by high-temperature processing (e.g., firing or sintering) of oxide-based or non-oxide-based compounds (including, but not limited to, metal oxides, nitrides, carbides, borides, and silicides). Ceramic materials may be generally crystalline or partially crystalline in structure. Ceramic materials may be characterized by high chemical, thermal, and mechanical stability under a wide range of conditions.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may,” when used with respect to a material, article, feature, or method act, indicates that such is contemplated for use in implementation of an embodiment of the disclosure, and such term is used in preference to the more restrictive term “is” so as to avoid any implication that other compatible materials, articles, features, and methods usable in combination therewith should or must be excluded.

As used herein, the term “configured” refers to a size, shape, material composition, and arrangement of one or more of at least one article and at least one apparatus facilitating operation of one or more of the article and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” and “approximately,” when either is used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, the singular forms “a,” “an,” and “the” are intended to include the plural forms as well, unless the context clearly indicates otherwise.

The following description provides specific details, such as material types and processing conditions, in order to provide a thorough description of embodiments of the disclosed materials and methods. However, a person of ordinary skill in the art will understand that the embodiments of the materials and methods may be practiced without employing these specific details. Indeed, the embodiments of the materials and methods may be practiced in conjunction with conventional techniques employed in the industry.

The processes described herein do not form a complete process flow for the related methods. The remainder of the methods are known to those of ordinary skill in the art. Accordingly, only the methods and conditions necessary to understand embodiments of the present materials and methods are described herein.

Reference will now be made to the figures, wherein like numerals refer to like components throughout. The drawings are not necessarily drawn to scale.

Advanced manufacturing systems and methods for producing radioactive articles that are reusable are disclosed. The radioactive articles may include radioactive fragments encapsulated within a substrate material. The radioactive isotope fragments may include matrix-embedded particles or non-embedded particles. The matrix-embedded particles or non-embedded particles may be intermixed in the substrate material such as a thermoplastic filament or an additive powder. The substrate material may be formed into a three-dimensional radioactive article using additive manufacturing methods such as material extrusion and powder bed fusion. The methods disclosed herein may allow for the formation of radioactive articles in shapes that are not possible to form using conventional methods, ensuring the safe containment of radioactive materials while enhancing safety standards by preventing the dispersion of radioactive particles and reducing exposure risk to personnel during production.

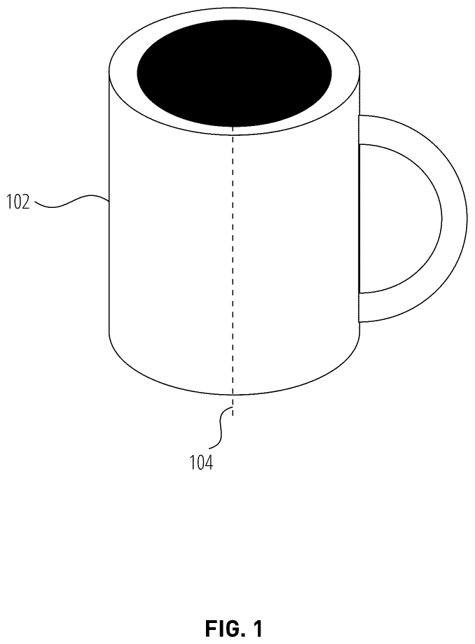

FIG. 1 illustrates an example of a radioactive article 102 that is reusable in accordance with embodiments of the disclosure. The article includes radioactive fragments-referred to herein as isotope fragments-encapsulated within the substrate material. While the radioactive article 102 is depicted herein as resembling a cup, the radioactive articles according to embodiments of the disclosure may resemble any household item, including, but not limited to, a remote control, a floor tile, a door knob, a picture frame, a lamp, or an area rug. The radioactive articles may simulate materials that have been contaminated with radioactivity for use in radioactive contamination emergency response training. Upon completion of the training, the radioactive articles may be gathered, stored, and reused in future contamination training.

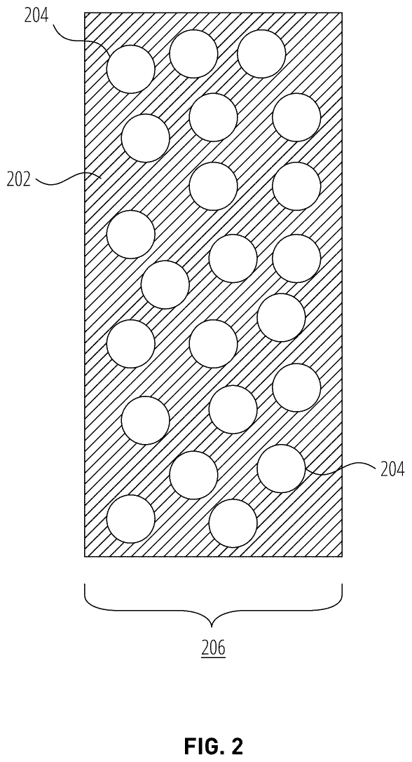

FIG. 2 schematically illustrates an enlarged cross-section of the radioactive article 102 seen about axis 104 to show a printing material 206 from which the radioactive article 102 may be formed. The printing material 206 may include at least one substrate material 202 in which one or more isotope fragments 204 are contained (e.g., encapsulated). In some embodiments, the printing material 206 includes a reactant material (e.g., a non-radioactive precursor material) distributed in the substrate material 202, and an additive manufacturing process forms an unactivated article in which the reactant material is distributed in the substrate material. After formation of the unactivated article, at least a portion of the article may be irradiated (e.g., using neutron irradiation in a reactor) to convert at least a portion of the reactant material into radioactive isotope material, as discussed in further detail below.

The substrate material 202 may include a thermoplastic filament. The thermoplastic filament may include a high-performance thermoplastic polymer formulated for durability under radiation exposure and field deployment, such as one or more of acrylonitrile butadiene styrene (ABS), polyethylene terephthalate glycol (PETG), thermoplastic polyurethane (TPU), thermoplastic elastomer (TPE), nylon, acrylonitrile styrene acrylate (ASA), polyvinyl butyral (PVB), high impact polystyrene (HIPS), polyvinyl alcohol (PVA), polycarbonate (PC), polyetherimide (PEI), polyether ether ketone (PEEK), polyetherketoneketone (PEKK), polyvinylidene fluoride (PVDF), polyphenylsulfone (PPSU), polylactic acid (PLA). In other embodiments, the substrate material 202 may include a ceramic material. The ceramic material may include, but is not limited to, alumina (Al₂O₃), silicon nitride (Si₃N₄), silicon carbide (SiC), and zirconia (ZrO₂).

The reactant material may include an activatable rare-earth oxide or salt (e.g., europium oxide (Eu₂O₃), gadolinium oxide (Gd₂O₃), or salts thereof) dispersed throughout the substrate material. By way of example, Eu₂O₃ may be dispersed in PEEK in an amount of from about 0.1 wt. % to about 10 wt. % (e.g., about 0.2 wt. % to about 1 wt. %). The resulting Eu-doped thermoplastic polymer may be formed into a filament or other feedstock for material extrusion additive manufacturing, and the radioactive article 102 may be subsequently irradiated to activate the europium throughout the radioactive article 102.

The substrate material 202 may alternatively include an additive powder material. The additive powder material may include a metal powder material or a polymer powder material, such as one or more of stainless steel, cobalt, copper, titanium, nylon, glass filled nylon, TPU, tungsten, and polypropylene.

The substrate material 202 may be formulated or otherwise configured so as not to attenuate the desired detectable radiological characteristics and signatures of the isotope fragments 204. For example, the substrate material 202 may be selected or formed to have a density that permits detection of the radioactivity of the isotope fragments 204 through the substrate material 202. In some embodiments, the substrate material 202 may attenuate beta radiation but not gamma radiation of the isotope fragments 204. In some embodiments, the substrate material 202 is configured to attenuate gamma radiation of the isotope fragments 204. The substrate material 202 may additionally be formulated or otherwise configured so as to maintain structural integrity under exposure to radiation and to prevent impairment of mechanical properties of the radioactive article 102 during handling and deployment. At least once encapsulated within the substrate material 202, the isotope fragments 204 may exhibit low to no biological or environmental toxicity.

The printing material 206 may include the one or more isotope fragments 204 homogeneously distributed throughout the substrate material 202. The one or more isotope fragments 204 may be present in a low weight percentage of the printing material 206, such as from about 0.001 wt. % to about 20 wt. % of the total weight of the printing material 206, such as from about 0.001 wt. % to about 1 wt. %, from about 1 wt. % to about 5 wt. %, from about 5 wt. % to about 10 wt. %, from about 10 wt. % to about 15 wt. %, or from about 15 wt. % to about 20 wt. %.

The one or more isotope fragments 204 may include a radioactive isotope material. In some embodiments the radioactive isotope material may include an isotope with a moderate half-life (e.g., a half-life of from about 1 year to about 30 years), including, but not limited to, europium-152 (Eu-152) (¹⁵²Eu), europium-154 (Eu-154) (¹⁵⁴Eu), strontium-90 (Sr-90) (⁹⁰Sr), cesium-137 (Cs-137) (¹³⁷Cs), cobalt-60 (Co-60) (⁶⁰Co), barium-133 (Ba-133) (¹³³Ba), tritium (H-3), ruthenium-106 (Ru-106), californium-252 (Cf-252), krypton-85 (Kr-85), curium-244 (Cm-244) (²⁴⁴Cm), cadmium-109 (Cd-109) (¹⁰⁹Cd), iron-55 (Fe-55) (⁵⁵Fe), promethium-147 (Pm-147) (¹⁴⁷Pm), thallium-204 (Tl-204) (²⁰⁴Tl), antimony-125 (Sb-125) (¹²⁵Sb), and plutonium-241 (Pu-241) (²⁴¹Pu). In these embodiments, the isotope fragments 204 may be formed so as to be substantially free of isotopes with long half-lives (e.g., half-lives longer than about 30 years) and, at least when the isotope fragments 204 and the radioactive article 102 are initially fabricated, free of isotopes with short half-lives (e.g., half-lives shorter than about 1 year). In other embodiments, the radioactive isotope material may include an isotope with a short half-life (e.g., a half-life of from about 1 hour to about 1 year), including, but not limited to, selenium-75 (Se-75) (⁷⁵Se), iridium-192 (Ir-192) (¹⁹²Ir), copper-64 (Cu-64) (⁶⁴Cu), samarium-153 (Sm-153) (¹⁵³Sm), sulfur-35 (S-35) (³⁵S), iridium-194 (Ir-194) (¹⁹⁴Ir), fluorine-18 (F-18) (¹⁸F), potassium bromide (K-42 and Br-82) (⁴²K and ⁸²Br), technetium-99m (Tc-99m) (^{99m}Tc), gallium-68 (Ga-68) (⁶⁸Ga), thallium-201 (Tl-201) (²⁰¹Tl), iodine-123 (I-123) (¹²³I), indium-111 (In-111) (¹¹¹In), yttrium-90 (Y-90) (⁹⁰Y), iodine-131 (I-131) (¹³¹I), cerium-144 (Ce-144) (¹⁴⁴Ce), rhenium-186 (Re-186) (¹⁸⁶Re), rhenium-188 (Re-188) (¹⁸⁸Re), xenon-133 (Xe-133) (¹³³Xe), phosphorus-32 (P-32) (³²P), strontium-89 (Sr-89) (⁸⁹Sr), and radium-223 (Ra-223) (²²³Ra).

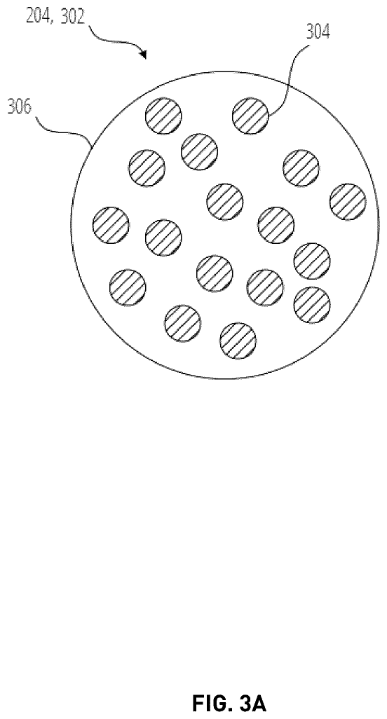

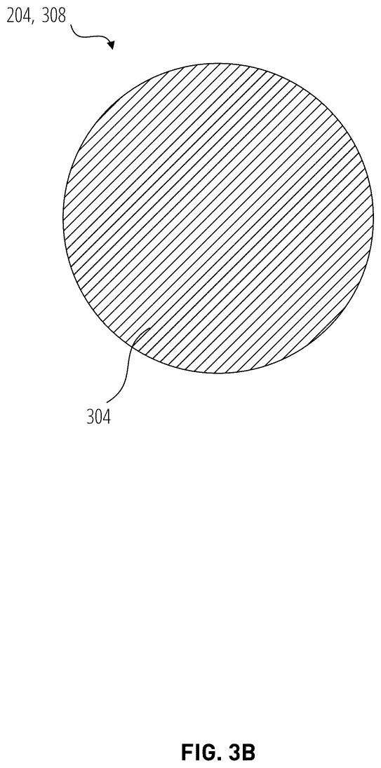

In one embodiment, the isotope fragment 204 may include a matrix-embedded particle. FIG. 3A illustrates a matrix-embedded particle 204, 302 according to embodiments of the disclosure. The matrix-embedded particle 204, 302 may include an irradiated particle 304 embedded in a matrix material 306.

To form the matrix-embedded particle 204, 302, at least one particle including a reactant material (e.g., a material that will be irradiated to provide the irradiated particle 304) may be combined—e.g., by a sol-gel technique—with one or more matrix materials 306 (e.g., glass, such as high-purity silica glass). During synthesis, the reactant material and matrix materials become intermixed, forming a sol-gel composite particle in which the reactant material particles are distributed throughout and embedded in the matrix material 306. The reactant material particles may then be irradiated to produce the at least one irradiated particle 304, which remains embedded within the matrix material 306.

For example, particles of Eu-151 and/or Eu-153—which are reactant materials from which target isotopes Eu-152 and/or Eu-154, respectively, may be derived—may be embedded in high-purity silica glass, annealed, and then activated (e.g., by neutron activation) to form at least one irradiated particle 304 of europium isotopes Eu-152 and/or Eu-154 embedded within the matrix material 306. At the time of the initial matrix embedding, the particles with the reactant material may be high-purity particles, and the use of high-purity silica glass as the matrix material 306 may be beneficial for the irradiation to avoid unwanted activation products.

The matrix-embedded particle 204, 302 may be substantially spherical in shape and have a diameter of from about 10 μm to about 400 μm, such as from about 10 μm to about 50 μm, from about 50 μm to about 100 μm, from about 100 μm to about 150 μm, from about 150 μm to about 200 μm, from about 200 μm to about 250 μm, from about 250 μm to about 300 μm, from about 300 μm to about 350 μm, or from about 350 μm to about 400 μm.

Embedding in a glass matrix material (e.g., the matrix material 306) may be performed using known sol-gel synthesis techniques. See, e.g., U.S. Patent Publication No. 2023/0339765 A1; Carney et al., “The Development of Radioactive Sample Surrogates for Training and Exercises,” Journal of Radioanalytical and Nuclear Chemistry, (2013), 296:769-773; and Carney et al., “The Development of Radioactive Glass Surrogates for Fallout Debris,” Journal of Radioanalytical and Nuclear Chemistry, (2014), 299:363-372, the disclosure of each of which is hereby incorporated herein in its entirety by this reference.

For example, a sol-gel precursor solution that includes a sol-gel precursor, an acid, solvents, and one or more dopants (e.g., one or more reactant materials) may be prepared. The one or more reactant materials may be procured in high purities to ensure unwanted isotopes or signatures are not produced during irradiation. Precise volumes of droplets of this solution may be dispensed onto a print surface, which may be hydrophobic, allowing control over the particle size and shape by adjusting factors like droplet volume, solution composition, and surface properties. The droplets may then be dried—either under ambient conditions or accelerated using heat—to remove solvents and form particles with homogeneously dispersed dopants. Optionally, the particles may undergo annealing at elevated temperatures (approximately 300° C. to approximately 700° C.) to further influence their size.

The sol-gel glass embedding process may facilitate control of the resulting size of the matrix-embedded particles 204, 302. For example, the volume of the solution droplets aliquoted to form the matrix material 306 (e.g., glass) may be controlled to tailor the resulting size of the matrix-embedded particle 204, 302. In other embodiments, once the matrix material 306 embedded with the particles that will become the irradiated particles 304 has been formed and solidified, the matrix-embedded particles 204, 302 may be ground or crushed to a smaller, desired size. In other embodiments, once the particle that will become the irradiated particle 304 is embedded in the matrix material 306, the resulting matrix-embedded particle 204, 302 may be incorporated into the substrate material 202 without further size adjustment.

Once embedded in the matrix material 306, and, optionally, annealed, the matrix-embedded reactant material may be irradiated to form the irradiated particles 304. The irradiation process may use, for example and without limitation, neutron- or photon-induced fission or photonuclear reactions (i.e., (γ, Xₙ) and (γ, Xₚ) reactions, wherein “γ” indicates incident gamma rays and “X” indicates a number of neutrons (ₙ) or protons (ₚ) emitted from the reactant material in the photonuclear reaction).

In other embodiments, the isotope fragment 204 may include a non-embedded particle. FIG. 3B illustrates a non-embedded particle 204, 308. To form a non-embedded particle 204, 308, a reactant material may be irradiated to form the irradiated particle 304 without first or subsequently being embedded in a matrix material 306. In these embodiments, the non-embedded particle 204, 308 may be formed of and include reactant materials (e.g., high-purity salts) that have been neutron-irradiated or Bremsstrahlung irradiated (which may otherwise be known in the art as “breaking radiation” or “deceleration radiation”). In some embodiments the reactant material includes a high-purity, rare-earth oxide or rare-earth salt (e.g., europium oxide and/or an europium salt) that is irradiated to form the non-embedded particles, and the non-embedded particles are directly incorporated into the substrate material during extrusion compounding to form the printing material.

The non-embedded particles 204, 308 may exhibit a diameter of from about 1 μm to about 150 μm, such as from about 1 μm to about 10 μm, from about 10 μm to about 50 μm, from about 50 μm to about 100 μm, or from about 100 μm to about 150 μm.

The irradiated particle 304 of the non-embedded particle 204, 308 and the irradiated particle 304 of the matrix-embedded particle 204, 302 may include a radioactive isotope material. In some embodiments the radioactive isotope material may include an isotope with a moderate half-life, including, but not limited to, one or more of europium-152 (Eu-152) (¹⁵²Eu), europium-154 (Eu-154) (¹⁵⁴Eu), strontium-90 (Sr-90) (⁹⁰Sr), cesium-137 (Cs-137) (¹³⁷Cs), cobalt-60 (Co-60) (⁶⁰Co), and barium-133 (Ba-133) (¹³³Ba), tritium (H-3), ruthenium-106 (Ru-106), californium-252 (Cf-252), krypton-85 (Kr-85), curium-244 (Cm-244) (²⁴⁴Cm), cadmium-109 (Cd-109) (¹⁰⁹Cd), iron-55 (Fe-55) (⁵⁵Fe), promethium-147 (Pm-147) (¹⁴⁷Pm), thallium-204 (Tl-204) (²⁰⁴Tl), antimony-125 (Sb-125) (¹²⁵Sb), and plutonium-241 (Pu-241) (²⁴¹Pu). In other embodiments, the radioactive isotope material may include an isotope with a short half-life including, but not limited to, selenium-75 (Se-75) (⁷⁵Se), iridium-192 (Ir-192) (¹⁹²Ir), copper-64 (Cu-64) (⁶⁴Cu), samarium-153 (Sm-153) (¹⁵³Sm), sulfur-35 (S-35) (³⁵S), iridium-194 (Ir-194) (¹⁹⁴Ir), fluorine-18 (F-18) (¹⁸F), potassium bromide (K-42 and Br-82) (⁴²K and ⁸²Br), technetium-99m (Tc-99m) (^{99m}Tc), gallium-68 (Ga-68) (⁶⁸Ga), thallium-201 (Tl-201) (²⁰¹Tl), iodine-123 (I-123) (¹²³I), indium-111 (In-111) (¹¹¹In), yttrium-90 (Y-90) (⁹⁰Y), iodine-131 (I-131) (¹³¹I), cerium-144 (Ce-144) (¹⁴⁴Ce), rhenium-186 (Re-186) (¹⁸⁶Re), rhenium-188 (Re-188) (¹⁸⁸Re), xenon-133 (Xe-133) (¹³³Xe), phosphorus-32 (P-32) (³²P), strontium-89 (Sr-89) (⁸⁹Sr), and radium-223 (Ra-223) (²²³Ra).

The printing material 206 may be formed into the radioactive article 102 by additive manufacturing methods, such as material extrusion or powder bed fusion. Additive manufacturing devices for material extrusion and powder bed fusion are known in the art.

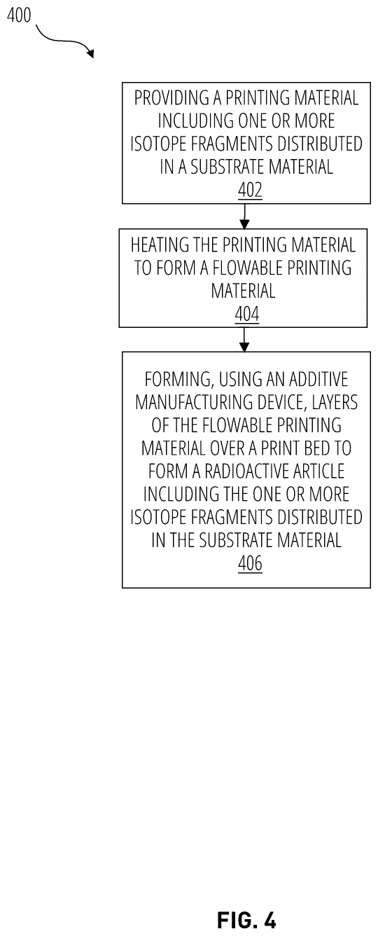

Referring to FIG. 4, in one embodiment, a method 400 of forming a radioactive article from the printing material 206 may include act 402 of providing a printing material including one or more isotope fragments distributed in a substrate material; act 404 of heating the printing material to form a flowable printing material; and act 406 of forming, using an additive manufacturing device, layers of the flowable printing material over a print bed to form a radioactive article including the one or more isotope fragments distributed in the substrate material.

Act 402 of providing a printing material including one or more isotope fragments distributed in a substrate material may include combining (e.g., intermixing) the one or more isotope fragments with the substrate material to produce the printing material. The one or more isotope fragments may include one or more matrix-embedded particles or one or more non-embedded particles. The substrate material may include a thermoplastic filament such as one or more of ABS, PETG, TPU, TPE, nylon, ASA, PVB, HIPS, PVA, PC, PEI, PEEK, PEKK, PVDF, PPSU, or PLA, or a ceramic material. Preparing the printing material may include homogenizing a mixture of the substrate material (e.g., the thermoplastic filament) and the one or more matrix-embedded particles or one or more non-embedded particles to achieve consistent dispersion of the isotope fragments throughout the substrate material. This homogenization may involve dry blending dried pellets of the substrate material with the isotope fragments to form an initial homogeneous mixture, followed by melt blending through extrusion compounding to produce the printing material using a twin-screw extruder configured to provide sufficient shear for uniform particle dispersion without degrading the substrate material or the isotope fragments. For example, the dry blending may include blending dried PEEK pellets with an irradiated europium-containing powder (e.g., an irradiated europium oxide powder) and the melt blending may include twin-screw extrusion compounding at a temperature sufficient to melt the PEEK to form a filament including the non-embedded particles dispersed throughout. The extruder's temperature profile may be carefully controlled to effectively melt the substrate material while preventing degradation. Optional additives, such as compatibilizers or dispersants, may also be incorporated to enhance particle dispersion and prevent agglomeration. As the material progresses through the extruder's mixing zones, shear forces and heat may uniformly distribute the matrix-embedded particles or the non-embedded particles within the substrate material to form the printing material (i.e., the substrate material intermixed with the one or more isotope fragments).

Act 404 of heating the printing material including the thermoplastic filament and the isotope fragments to form a flowable printing material may include increasing the temperature of the printing material above its melting point to achieve a flowable state that is suitable for extrusion. The printing material may be heated inside a chamber or nozzle of the additive manufacturing device to a temperature of from about 200° C. to about 500° C., such as from about 200° C. to about 300° C., from about 300° C. to about 400° C., or from about 400° C. to about 500° C. For example, melting temperature ranges may be from about 200° C. to about 300° C. for polymers like PLA or ABS, from about 300° C. to about 400° C. for materials like nylon or PC, or from about 400° C. to about 500° C. for high-performance polymers like PEEK or PEI. The temperature setting of the additive manufacturing device may be adjusted to balance the viscosity of the flowable printing material for smooth extrusion while maintaining the stability of the isotope fragments of the printing material. During act 404, the substrate material (e.g., the thermoplastic filament) may transition from a solid or semi-solid state to a molten, flowable state without undergoing any substantial chemical reactions. The isotope fragments may remain chemically and structurally stable throughout act 404.

Act 406 of forming, using an additive manufacturing device, layers of the flowable printing material over a print bed to form a radioactive article may include utilizing a material extrusion technique such as Fused Deposition Modeling (FDM) or Fused Filament Fabrication (FFF). The heated, flowable printing material may be extruded through a nozzle of the additive manufacturing device and deposited onto the print bed layer by layer according to a pre-programmed design. The additive manufacturing device may control parameters such as extrusion speed, layer thickness, and nozzle movement to ensure precise construction of the article. As the printing material is deposited, the layers may cool and become solidified to form a solid article with the isotope fragments uniformly dispersed throughout. The method 400 may also involve adjusting cooling rates to prevent thermal stresses and ensure strong interlayer adhesion. Post-processing acts may include heat treatment or annealing to relieve residual stresses, and surface finishing operations such as machining or polishing to enhance mechanical properties and achieve the desired surface quality. Additionally, evaluation techniques like X-ray computed tomography or ultrasonic testing may be employed to inspect the resulting article for internal defects or inconsistencies.

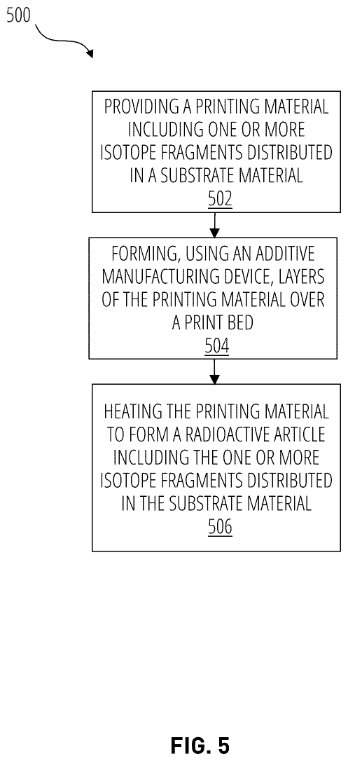

Referring to FIG. 5, in another embodiment, a method 500 of forming a radioactive article may include act 502 of providing a printing material including one or more isotope fragments distributed in a substrate material; act 504 of forming, using an additive manufacturing device, layers of the printing material over a print bed; and act 506 of heating the printing material to form a radioactive article including the one or more isotope fragments distributed in the substrate material.

Act 502 of providing a printing material including one or more isotope fragments distributed in a substrate material may include combining (e.g., intermixing) the one or more isotope fragments with the substrate material to produce the printing material. The one or more isotope fragments may include one or more matrix-embedded particles or one or more non-embedded particles. The substrate material may include an additive powder material (e.g., a metal powder or polymer powder) suitable for powder bed fusion processes, such as one or more of stainless steel, cobalt, copper, titanium, nylon, glass filled nylon, TPU, tungsten, and polypropylene. The isotope fragments may be thoroughly mixed with the substrate material through a homogenization process to achieve a substantially homogeneous distribution of the isotope fragments throughout the substrate material. The homogenization process may involve mechanical blending techniques such as ball milling, V-blending, or using a turbula mixer to ensure uniform dispersion. Parameters may be adjusted to prevent agglomeration of the isotope fragments and to maintain the flowability and packing density of the printing material. Additionally, the particle size distribution of the substrate material and the isotope fragments may be matched or adjusted to facilitate uniform mixing and prevent segregation during handling and processing.

Act 504 of forming, using an additive manufacturing device, layers of the printing material over a print bed may include depositing a thin, substantially uniform layer of the printing material (i.e., the substrate material intermixed with the isotope fragments) onto the print bed of a powder bed fusion device. This layering may be achieved using a recoating mechanism that spreads the printing material evenly across the build area. Each layer's thickness may be precisely controlled and may range from about 20 μm to about 100 μm, depending on the specifications of the article being formed and the capabilities of the additive manufacturing device. The process may be repeated for each subsequent layer, with the additive manufacturing device following a schematic defined by a digital 3D model of the radioactive article. The additive manufacturing device may be equipped with sensors and control systems to monitor and adjust parameters such as layer thickness, powder bed temperature, and environmental conditions. An inert atmosphere, such as argon or nitrogen gas, may be utilized within the additive manufacturing device to prevent oxidation or contamination of the printing material during the formation of the radioactive article. The isotope fragments may remain chemically and structurally stable throughout act 504.

Act 506 of heating the printing material to form a radioactive article may include applying a heat source, such as a high-energy laser or electron beam, to the printing material to selectively fuse the substrate material (i.e., the additive powder material). The heat source may be directed according to the programmed design to melt the substrate material of the printing material. The process parameters, such as laser power, scan speed, and focus, may be adjusted to achieve effective fusion of the substrate material. After each layer has been selectively fused and solidified, the build platform may be lowered by the thickness of one layer, and the next layer of printing material may be applied, repeating the process until the entire article is formed. Post-processing acts may include removing any unfused printing material from the additive manufacturing device, heat treatment or annealing to relieve residual stresses, and surface finishing operations such as machining or polishing to enhance mechanical properties and achieve the desired surface quality. Additionally, evaluation techniques like X-ray computed tomography or ultrasonic testing may be employed to inspect the final article for internal defects or inconsistencies.

In some embodiments, an unactivated article may be formed using the additive manufacturing process and later irradiated to form a radioactive article. For example, a method of forming a radioactive article may include providing a printing material including a reactant material distributed in a substrate material; forming, using an additive manufacturing device, the printing material into an unactivated article; and, after forming the unactivated article, irradiating at least a portion of the unactivated article to convert at least a portion of the reactant material into radioactive isotope material. The irradiation may form one or more isotope fragments (e.g., the radioactive isotope material in the form of a matrix-embedded particle or a non-embedded particle) in situ within the substrate material and produce the radioactive article. Irradiating may include neutron irradiation (e.g., in a reactor), photon irradiation (e.g., Bremsstrahlung irradiation), and/or inducing a photonuclear reaction, and may be applied to the entire unactivated article or selectively to one or more portions of the unactivated article (e.g., while shielding other portions) to form hot spots and/or an activity gradient. Post-print activation may facilitate inspection and rejection of defective parts prior to irradiation, reduce worker exposure during fabrication, and simplify shipment of unactivated structures to an irradiation facility.

Properties of any of the radioactive articles 102, the irradiated particles 304, and/or the isotope fragments 204 according to embodiments of the disclosure may be tailored according to desired training, testing, or researching uses of the radioactive articles 102. For example, with regard to the composition of the irradiated particles 304, each irradiated particle 304 within the isotope fragments 204 of the radioactive article 102 may consist substantially of isotopes of a single chemical element (e.g., only europium isotopes, such as ¹⁵²Eu and/or ¹⁵⁴Eu). In other embodiments, isotopes of more than one chemical element (e.g., both europium isotopes and, e.g., selenium isotopes, such as ⁷⁵Se) may be included in each of one or more of the irradiated particles 304. Accordingly, the isotope composition of each isotope fragment 204 may be tailored.

The degree of radioactivity within a given radioactive article 102 may also be tailored. For example, in some embodiments, the isotope fragments 204 may be substantially evenly distributed throughout the area of a given radioactive article 102. Therefore, the detectable radioactivity level may be substantially consistent across the radioactive article 102. In other embodiments, one or more areas of a radioactive article 102 may be configured to exhibit a greater degree of radioactivity so as to simulate so-called “hot spots” within the radioactive article 102 or within a group of the radioactive articles 102. The isotope fragments 204 may be distributed predominantly in certain locations or spots of the radioactive article 102.

As a more particular example, the isotope fragments 204 within a given radioactive article 102 may be in the form of the matrix-embedded particle 204, 302 of FIG. 3A, and each isotope fragment 204 may include Eu isotopes Eu-152 and/or Eu-154 as the irradiated particles 304 embedded within the matrix material 306, which may be a sol-gel formed silica glass. For example, 10 grams of activated sol-gel glass (e.g., the isotope fragments 204 in the form of the matrix-embedded particles 204, 302 of FIG. 3A) with a loading density of about 100 mg/g (e.g., 100 milligrams of irradiated particle 304 (e.g., Eu-152 and/or Eu-154 particles) per gram of glass matrix material 306) would produce 88.8 MBq (2.4 mCi) of activity. The 88.8 MBq (2.4 mCi) activity would produce a dose-rate of about 1.1 mSv/hr (about 110 mrem/hr) at 30 cm from the isotope fragments 204. The 10 grams of activated sol-gel glass (e.g., the 10 grams of isotope fragments 204) may be distributed (e.g., evenly distributed throughout, distributed in a gradient throughout, or concentrated in hot spot areas) in the substrate material 202 (e.g., polymer material) of the radioactive article 102.

In another particular example, radioactive tiles may be fabricated according to embodiments of the disclosure. The tiles may measure approximately 12″×12″ and contain a uniform distribution of sol-gel particles loaded with activated source materials. A tile incorporating potassium bromide (KBr) may be prepared to achieve a dose rate of about 1 milliroentgen per hour (mR/hr) at a distance of 2 inches. Approximately 17,956 particles of KBr embedded in sol-gel, each about 250 microns in diameter, may be arranged at 2 millimeter spacing and may collectively contain a total KBr activity of about 8.13×10⁻⁶ Ci, or about 4.53×10⁻¹⁰ Ci per particle. The KBr loading per particle may be approximately 5×10⁻⁹ grams, yielding a total KBr mass in the tile of about 0.00023 grams and a specific activity of about 0.0364 Ci/g. Following irradiation, the tile may have an expected dose rate of about 0.0001319 R/hr at a distance of 1 foot, equivalent to approximately 4.7 mR/hr at a distance of 2 inches, based on a gamma constant of about 16.225 R/hr/Ci at a distance of 1 foot.

A similar 12″×12″ tile may be fabricated with europium (Eu-152) as the source material. The tile may include 17,956 particles of Eu-152 embedded in sol-gel, each about 250 microns in diameter, at 2 mm spacing. The tile may yield a total Eu-152 activity of about 1.92×10⁻⁵ Ci, or about 1×10⁻⁹ Ci per particle. Each particle may contain approximately 6×10⁻⁸ grams of Eu-152, totaling about 0.00000011 grams with a specific activity of about 174 Ci/g. After irradiation, the tile may have an expected dose rate of about 0.0001276 R/hr at 1 foot, which translates to approximately 4.59 mR/hr at 2 inches, considering a gamma constant of about 6.647 R/hr/Ci at a distance of 1 foot.

The radioactive articles of embodiments of the disclosure facilitate a tailorable training, testing, or researching approach while also facilitating repositioning and reuse of the radioactive articles, which are reusable. The radioactive articles may be used in indoor or outdoor environments.

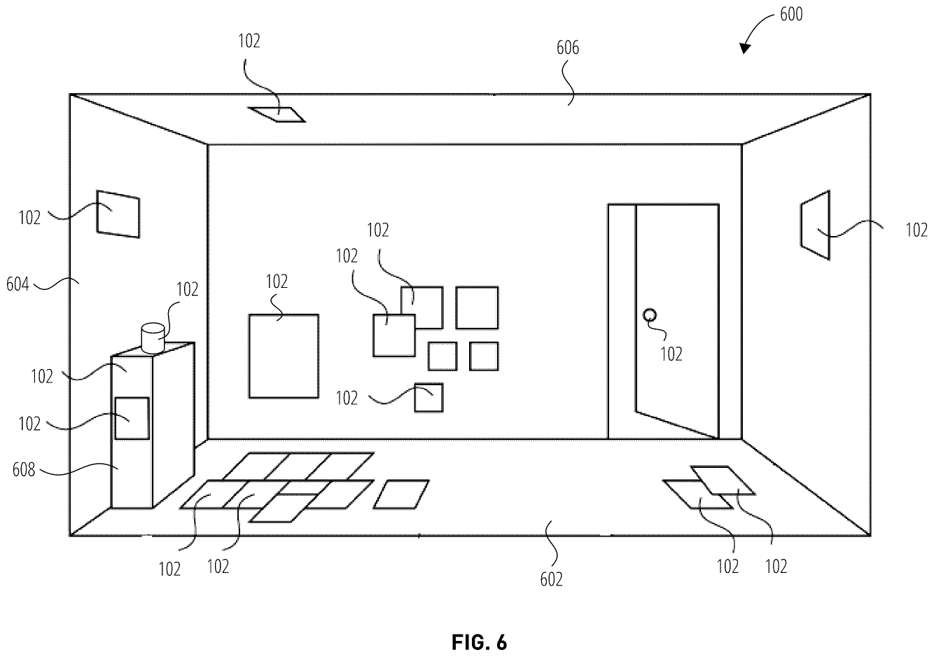

For example, with reference to FIG. 6, one or more of the radioactive articles 102 may be placed throughout a training venue (e.g., a room 600) to produce a realistic large-area contamination environment. The radioactive articles 102 may, for instance, be selectively placed on a floor 602, on walls 604, on a ceiling 606, and/or on furniture 608. Alternatively, the radioactive articles 102 may be placed under other items in the room, such as under a rug. In some areas, multiple radioactive articles 102 may be at least partially overlapped with one another. In some areas, multiple radioactive articles 102 may be positioned in a close arrangement of the radioactive articles 102 directly adjacent to one another. In other areas, the radioactive articles 102 may be positioned in a more spread-out arrangement. In some embodiments, different sizes and shapes of the radioactive articles 102 may be present in the same room. For example, the radioactive articles 102 may be in the shape of a cup or a door handle. Accordingly, the radioactive articles 102 facilitate preparation of a facility, such as a room, with any number of different configurations of the radioactive articles 102 for simulating a radioactive contamination environment.

Once the radioactive articles 102 are selectively placed in the training, testing, or research environment, the radioactive articles 102 may be useful for the whole of the training, testing, or researching session—whether hours, days, weeks, or months—without an additional application of radioactive material, in contrast to conventional liquid-sprayed surrogate solutions that may use several spray applications during a single, hours-long training session.

In some embodiments, after use, the radioactive articles 102 may be collected and stored and reused for future contamination training events, providing a cost effective and safe method of conducting contamination training. For example, while conventional single-use, surrogate isotope solutions may cost thousands of US dollars to produce and use, the production of the radioactive articles 102 in accordance with embodiments of the disclosure may provide a training tool at a one-time cost that may be used for multiple years. Therefore, preparing replacement radioactive articles 102 may not be necessary for several years. Additionally, the methods according to embodiments of the disclosure may facilitate the production of articles having complex geometries (e.g., cups, remotes, door handles, etc.). For example, a metal powder intermixed with encapsulated isotope fragments according to embodiments of the disclosure may be used in a powder bed fusion process to form (e.g., directly print) complex geometries that were previously unattainable with conventional methods.

The methods according to embodiments of the disclosure may also be used to produce alternatives for special form radioactive materials (e.g., sealed iodine-125 or palladium-103 capsules) for use in medical applications. For example, additive manufacturing techniques such as powder bed fusion or material extrusion may be employed to fabricate an entire special form radioactive material and its encapsulation as a single, integrated piece.

In medical applications such as brachytherapy, radioactive seeds containing isotopes like iodine-125 or palladium-103 are conventionally manufactured by encapsulating the radioactive material within titanium capsules. This conventional process involves multiple acts of handling radioactive materials, precision machining, and welding, which can be labor-intensive and carry significant safety risks to personnel due to potential exposure. Similarly, industrial sources like cobalt-60 used for radiography or gamma irradiation are conventionally produced by encasing the radioactive material within steel or other metal housings. The assembly uses meticulous placement of the radioactive elements and extensive welding to ensure secure containment. These conventional methods demand stringent safety protocols to prevent contamination and ensure the integrity of the encapsulation, often limiting the design to simple geometries due to manufacturing constraints.

The methods according to embodiments of the disclosure facilitate the production of special form radioactive materials without such stringent safety protocols and design limitations. For example, a metal powder intermixed with encapsulated isotope fragments may be used in a powder bed fusion process to form (e.g., directly print) complex geometries that were previously unattainable. This approach also eliminates the handling of loose radioactive materials and performing multiple welding operations, significantly reducing labor and exposure risks. Moreover, the ability to produce complex geometries allows for the production of radioactive sources with enhanced functionality. In the case of iridium sources, instead of irradiating wafers and assembling them into hardened articles, the iridium source may be printed with internal features that control radiation emission profiles. This may lead to more efficient radiation therapy treatments or improved imaging capabilities. Additionally, patient-specific implants may be formed, allowing for precise targeting to a treatment area, which improves patient outcomes, minimizes risks and improves treatment efficiency. The ability to tailor the implants may improve treatment outcomes by ensuring radiation is delivered specifically to the treatment area, minimizing exposure to the surrounding area or sensitive organs. Tailoring the size and shape of the implant allows it to conform to a patient's anatomy, ensuring precise placement and radiation coverage in complex areas like the spine or skull, or for tumors with irregular or asymmetric shapes. In some embodiments, the radioactive articles may include a substrate material (e.g., steel, tungsten, etc.) formulated to attenuate radiation, which shields or reduces the exposure of healthy tissue while precisely targeting the treatment area.

The methods according to embodiments of the disclosure may also facilitate production of materials for neutron irradiation applications. For example, components made from materials like europium or gadolinium may be additively manufactured to serve as both structural elements and neutron absorbers, providing a more efficient and cost-effective solution for nuclear reactors or medical devices.

By using additive manufacturing, the methods according to embodiments of the disclosure offer significant advancements over conventional techniques, enabling the production of specialized radioactive sources with complex geometries and improved performance. The fabrication process allows for flexibility in material selection based on specific application needs and limits material waste. The methods and systems according to embodiments of the disclosure also enhance safety by preventing the dispersion of radioactive particles and reducing exposure to personnel during production.

### Example

Six sol-gel samples were irradiated at the Washington State University (WSU) Training, Research, and Isotopes General Atomics (TRIGA) reactor. Samples included the following:
Three, blank (non-impregnated) samples at 1.1273 g, 1.5642 g, 0.9394 g with a diameter of 250 μm.
Three, europium impregnated samples at 1.1544 g, 0.9916 g, 1.1119 g with a diameter of 250 μm. Samples were impregnated with europium oxide at a loading of 0.001 g (6E-8 g europium per particle).

All six samples were transferred to poly irradiation vials and irradiated in the WSU-NSC TRIGA reactor. Samples were irradiated in the D8 position (epi-thermal flux: 5.87×10¹² n/cm² s⁻¹; thermal flux: 2.00×10¹¹ n/cm² s⁻¹) for 500 seconds.

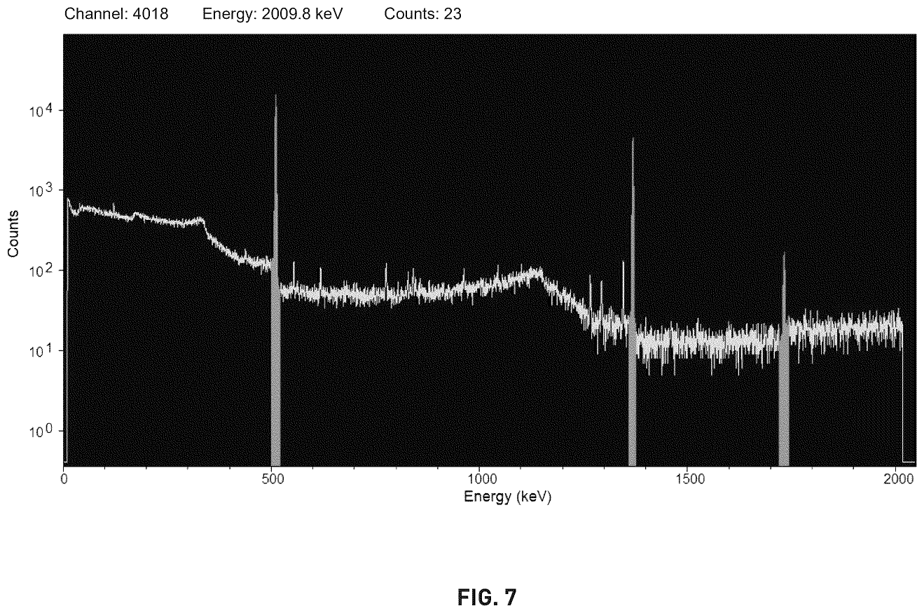

Non-impregnated samples were irradiated to evaluate impurities found within the silica starting material and impurities incurred during the sol-gel synthesis. Silica has three stable isotopes: Si-28 (92.25%), Si-29 (4.67%) and Si-30 (3.07%). Silica-31 is the primary activation product and has a half-life of 157-minutes. FIG. 7 displays the spectrum at approximately 20 hours post irradiation. Primary peaks observed at 1731.86 keV, 1368.63 keV and 510.64 keV can be attributed to Na-24. Although minor peaks can be observed, adequate time had not passed to clearly observe impurities within the spectrum.

About 48 hours post-irradiation, europium-152/154 impregnated samples (i.e., Eu sol-gels) were analyzed. The spectral analysis of the three europium samples displayed nearly identical results.

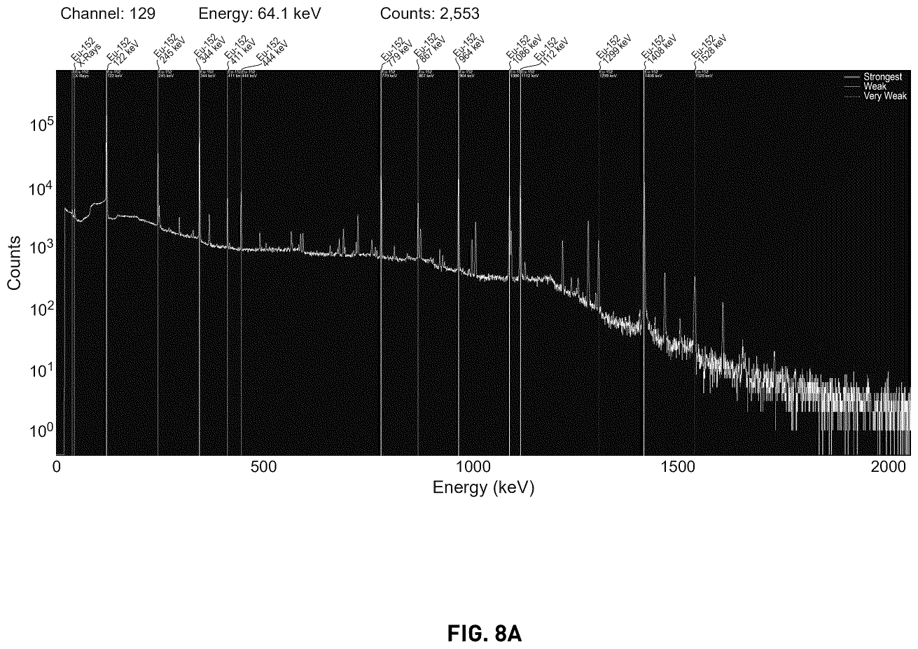

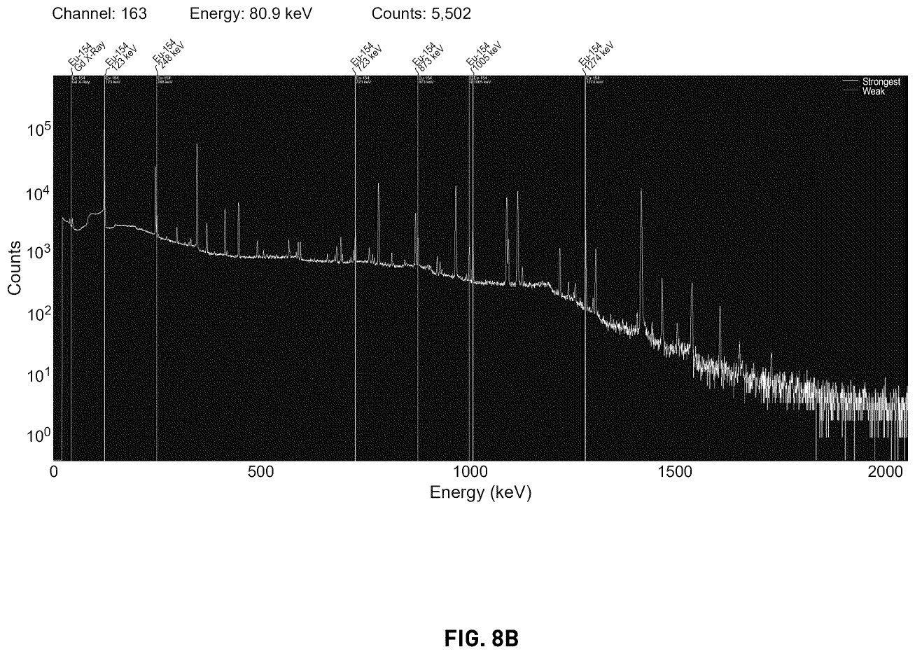

FIG. 8A displays the gamma spectrum for europium impregnated sol-gel glass with the gamma lines identified for Eu-152. The primary gamma lines and percent intensity of Eu-152 are 121.78 KeV (28.53), 1408.013 KeV (20.87), 964.057 KeV (14.51), 1112.076 KeV (13.67), 1085.837 KeV (10.11).

FIG. 8B displays the gamma spectrum for europium impregnated sol-gel glass with the gamma lines identified for Eu-154. The primary gamma lines and percent intensity of Eu-154 are 123.07 KeV (40.4), 1274.42 KeV (34.8), 723.30 KeV (20.06), 1004.76 KeV (18.01), 873.18 KeV (12.08).

A feature missing from the spectrum are the gamma lines associated with Si-31 and Na-24, which were identified in the spectrum of irradiated sol-gel glass void of europium. Silica-31 and Na-24 have half-lives of 157.24 minutes and 14.956 hours, respectively. No measurable gamma lines were identified for Si-31 and Na-24, as these isotopes had gone through decay of greater than 70× half-lives.

Another feature missing from the spectrum is the gamma lines associated with Eu-152m. Eu-152m has a half-life of 9.31 hours, which eliminated any identification within the spectrum due to decay. Standard gamma lines associated with background gamma rays were identified. The only remaining gamma signatures are for those identified for Eu-152/154.

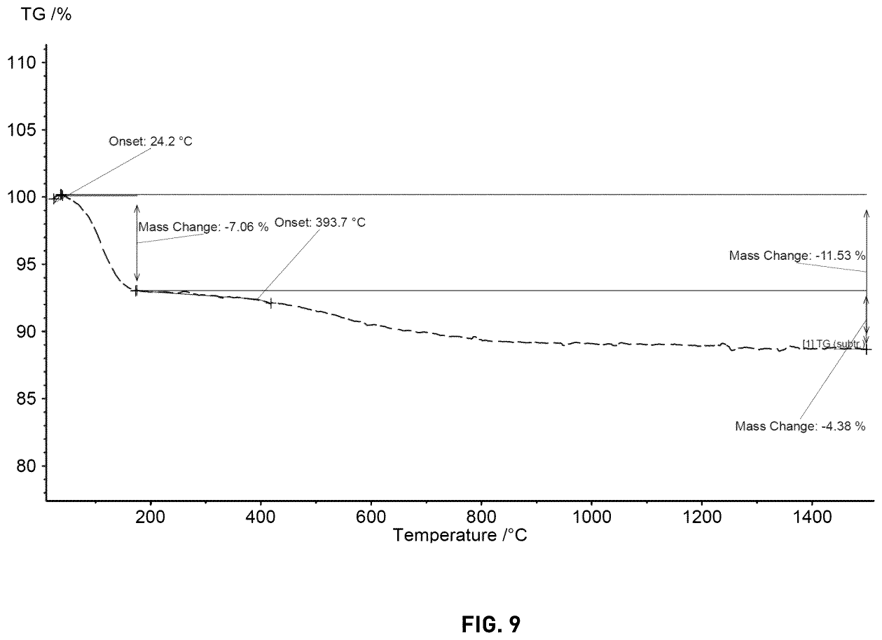

Thermogravimetric Analysis (TGA) is a thermal analysis technique that measures changes in the physical and chemical properties of materials as a function of time and temperature. Blank samples of sol-gel glass particles were analyzed under argon gas to control the sample environment. With reference to FIG. 9, a mass change of 7.06% can be observed at the onset temperature of 24.2° C. This mass drop early in the temperature cycle is a common feature of water evaporation and not of a chemical reaction. A second mass change of 4.47% drop is observed at the onset temperature of 393.7° C. This is also likely due to evaporation of unbonded water within the pore structure as sol-gel production includes the precursors of silica-oxide, ethanol and water. The mass reached steady state at approximately 800° C., indicating thermal stability. In general, blank sol-gel glass was relatively stable through a temperature sequence from approximately 200° C.-1450° C.

A second set of measurements of the europium-152/154 impregnated samples (i.e., the Eu sol-gels) and the blank (non-impregnated) samples were taken following about 7 months of decay. 344 keV and 1274 keV photon energy levels were used for activity calculations for ¹⁵²Eu and ¹⁵⁴Eu, respectively. The Eu sol-gels were measured lengthwise at a distance of 3 cm from the detector face to the leading edge of the Eu sol-gel container.

The measurement parameters are shown in Table 1:

TABLE 1

| | | | | Live | |
|---|---|---|---|---|---|
| | Measurement | Measurement | | Counting | Dead |
| Sample | Start Date | Start Time | | Time (sec) | Time (%) |
| Blank1 | Oct. 14, 2024 | 10:55:07 | AM | 24850 | 0.04 |
| Blank2 | Oct. 17, 2024 | 11:26:42 | AM | 17801 | 0.04 |
| Blank3 | Oct. 22, 2024 | 11:15:44 | AM | 80348 | 0.04 |
| Eu4 | Oct. 16, 2024 | 11:27:39 | AM | 80035 | 16.95 |
| Eu5 | Oct. 14, 2024 | 5:50:25 | PM | 56225 | 12.07 |
| Eu6 | Oct. 16, 2024 | 2:36:23 | PM | 58543 | 21.67 |
| Background | Oct. 17, 2024 | 4:23:57 | PM | 413275 | 0.04 |

The measurement results from each photopeak of interest are shown in Table 2:

TABLE 2

| | | | | | Minimum |
|---|---|---|---|---|---|
| | | Activity at | Uncer- | Percent | Detectable |
| | | Measurement | tainty | Uncer- | Activity |
| Sample | Isotope | (Bq) | (1σ) | tainty | (MDA) (Bq) |
| Blank1 | ¹⁵²Eu | <MDA | | | 7.63E−01 |
| | ¹⁵⁴Eu | <MDA | | | 1.40E+00 |
| Blank2 | ¹⁵²Eu | 1.06E+01 | 5.21E−01 | 4.91 | 1.06E+00 |
| | ¹⁵⁴Eu | <MDA | | | 1.95E+00 |
| Blank3 | ¹⁵²Eu | 2.31E+00 | 1.38E−01 | 5.97 | 2.36E−01 |
| | ¹⁵⁴Eu | <MDA | | | |
| Eu4 | ¹⁵²Eu | 4.39E+04 | 1.39E+03 | 3.17 | 2.37E−01 |
| | ¹⁵⁴Eu | 3.86E+03 | 1.05E+02 | 2.71 | 4.34E−01 |
| Eu5 | ¹⁵²Eu | 3.06E+04 | 9.70E+02 | 3.17 | 3.37E−01 |
| | ¹⁵⁴Eu | 2.70E+03 | 7.33E+01 | 2.71 | 6.18E−01 |
| Eu6 | ¹⁵²Eu | 5.77E+04 | 1.83E+03 | 3.17 | 3.24E−01 |
| | ¹⁵⁴Eu | 5.19E+03 | 1.41E+02 | 2.71 | 5.93E−01 |

The uncertainty budget (e.g., the quantified contributions of all potential sources of measurement error) for each variable used in the calculation of activity is shown in Table 3:

TABLE 3

| | | | Branching | Detector | Half- |
|---|---|---|---|---|---|
| Sample | Isotope | Counts | Ratio | Efficiency | Life |
| Blank1 | ¹⁵²Eu | — | — | — | — |
| | ¹⁵⁴Eu | — | — | — | — |
| Blank2 | ¹⁵²Eu | 58.31 | 15.49 | 26.20 | 0.00 |
| | ¹⁵⁴Eu | — | — | — | — |
| Blank3 | ¹⁵²Eu | 71.87 | 10.45 | 17.68 | 0.00 |
| | ¹⁵⁴Eu | — | — | — | — |
| Eu4 | ¹⁵²Eu | 0.01 | 37.15 | 62.85 | 0.00 |
| | ¹⁵⁴Eu | 0.18 | 12.64 | 87.18 | 0.00 |
| Eu5 | ¹⁵²Eu | 0.01 | 37.15 | 62.84 | 0.00 |
| | ¹⁵⁴Eu | 0.36 | 12.62 | 87.02 | 0.00 |
| Eu6 | ¹⁵²Eu | 0.01 | 37.15 | 62.85 | 0.00 |
| | ¹⁵⁴Eu | 0.18 | 12.64 | 87.18 | 0.00 |

Finally, Table 4 shows the ratio of the expected ratio of activities from ¹⁵²Eu and ¹⁵⁴Eu based on irradiation in a TRIGA reactor:

TABLE 4

| | Ratio of | | Spectrum Weighted Cross | | |
|---|---|---|---|---|---|
| | ¹⁵²Eu/¹⁵⁴Eu | | Section from TRIGA | | TRIGA |
| | | Half- | (barns) | | Expected |
| Sample | Activity | Life | ¹⁵¹Eu(n,γ)¹⁵²Eu | ¹⁵³Eu(n,γ)¹⁵⁴Eu | Value |
| Blank1 | — | 1.57 | 2855 | 146 | 12.46 |
| Blank2 | 10.09 | | (with some | (with some | (with some |
| | (2.40) | | absorption: | absorption: | absorption: |
| Blank3 | 12.67 | | 1772) | 104) | 10.82) |
| | (4.89) | | | | |
| Eu4 | 11.37 | | | | |
| | (0.47) | | | | |
| Eu5 | 11.32 | | | | |
| | (0.47) | | | | |
| Eu6 | 11.12 | | | | |
| | (0.46) | | | | |

The first column shows the measured values, and the two rightmost columns give the expected ratios that correspond to the first column. With introduction of a small amount of thermal neutron shielding (e.g., an irradiation capsule), the ratio decreased, which means that the ratio of ¹⁵²Eu/¹⁵⁴Eu was sensitive to the neutron spectrum. The observed activity ratios were consistent with those expected from a TRIGA reactor irradiation process.

### Example 2

A composite thermoplastic printing material including polyether ether ketone (PEEK) and sol-gel particles was prepared and extruded into filament for material extrusion additive manufacturing. The sol-gel particles included activated europium-containing beads and provided europium-152 (Eu-152) and europium-154 (Eu-154) isotope fragments distributed within the PEEK substrate material.

A filament was produced with a diameter of 1.75 mm±0.05 mm and a spool mass greater than 1 kg. The sol-gel particle loading was 0.1-1.0 wt %, and the sol-gel particle size was 250 μm.

The filament was printed using a material extrusion process to evaluate printability and part quality, and print parameters were tailored for the PEEK/sol-gel composite. The nozzle temperature was 385° C. to 395° C., and no nozzle clogging was observed. Layer adhesion was excellent, and printed parts achieved a dimensional accuracy of +0.1 mm.

A 12 inch×12 inch PEEK tile was fabricated using the filament. Microscopy of the fabricated tile showed uniform sol-gel particle distribution throughout the tile volume. Gamma spectroscopy of the fabricated tile showed a clean Eu-152/154 spectrum. A contamination survey was performed, and no surface contamination was detected (<20 dpm/100 cm²). Structural integrity evaluation showed no defects, voids, or delamination.

### Example 3

A thermoplastic filament including polyether ether ketone (PEEK) doped with europium oxide (Eu₂O₃) was prepared for subsequent post-print activation. The europium-doped filament included 0.2 wt % Eu₂O₃ dispersed in the PEEK matrix.

Prior to printing, the filament was dried in a vacuum oven at 150° C. for 4 hours to reduce surface beading, improve interlayer adhesion, and provide reproducible print quality.

The europium-doped PEEK filament was printed using a material extrusion process. Print processing conditions included a print temperature of from 390° C. to 400° C., a build chamber temperature of about 100° C., a print speed of from 35 mm/s to 40 mm/s, a layer height of about 0.2 mm, and 100% infill.

Two 12 inch×12 inch tiles were printed with a three-layer construction configured to fully encapsulate the europium-doped region within stable PEEK. Each tile included a bottom region of from 1 mm to 2 mm pure PEEK, a core region of from 3 mm to 4 mm europium-doped PEEK at 0.2 wt % Eu₂O₃, and a top region of from 1 mm to 2 mm pure PEEK. The tiles also included pure PEEK perimeters encasing the core region.

The printed tiles were transferred to the Washington State University (WSU) Training, Research, Isotopes, General Atomics (TRIGA) reactor and post-print activated. Gamma spectroscopy confirmed activity distributed uniformly across the tile area and only Eu-152/154 peaks present in the spectra. Containment was verified by contamination surveys showing zero surface contamination on the exterior layers. Core activity was predictable from europium loading, and total tile activity was controlled by core thickness, including about 2-3 μCi per tile for a 3 mm core and about 4-6 μCi per tile for a 5 mm core.

Mechanical properties of printed specimens were evaluated using ASTM D638 Type V dog-bone tensile specimens fabricated via fused filament fabrication (FFF) using (i) pure PEEK filament and (ii) europium-doped PEEK filament at 0.2 wt % Eu₂O₃. Specimens were conditioned at 23° C. and 50% relative humidity for 48 hours and tested on a universal testing machine at a crosshead speed of 5 mm/min. Average tensile strength was 77 MPa for pure PEEK and 68 MPa for europium-doped PEEK.

Radiolysis testing was performed by exposing printed tensile specimens to a cobalt-60 gamma irradiator to simulate lifetime radiation exposure. Dose levels included 1×, 5×, 10×, and 100× lifetime equivalent doses corresponding to approximately 87.6 R, 438 R, 876 R, and 8,760 R. After exposure, tensile properties were evaluated. Pure PEEK exhibited <2% tensile strength change at the 1× lifetime dose, a 4.3% tensile strength reduction at the 10× lifetime dose, and an 8.7% tensile strength reduction at the 100× lifetime dose. Europium-doped PEEK (0.2 wt % Eu₂O₃) exhibited <5% property change at the 10× lifetime dose, indicating that europium doping did not materially reduce radiation tolerance for the tested conditions.

Environmental exposure testing was performed to evaluate suitability for field deployment. Specimens were subjected to temperature cycling from −20° C. to +60° C. for 30 cycles, humidity exposure at 90% relative humidity at 40° C. for 30 days, and UV exposure using a 365 nm UV lamp for 500 hours. Following UV exposure, PEEK exhibited minimal color change and <3% property degradation. Following temperature cycling, no warping, cracking, or dimensional changes were detected. Following humidity exposure, PEEK exhibited <1% mass change, indicative of minimal water absorption. In a combined sequential exposure to UV, humidity, and temperature cycling intended to simulate outdoor deployment, post-exposure mechanical testing showed <10% property change.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of forming a radioactive article, the method comprising:
providing a printing material comprising one or more isotope fragments distributed in a substrate material; and
forming, using an additive manufacturing device, the printing material into a radioactive article comprising the one or more isotope fragments distributed in the substrate material.

2. The method of claim 1, wherein the one or more isotope fragments comprise one or more of europium-152 (Eu-152) (¹⁵²Eu), europium-154 (Eu-154) (¹⁵⁴Eu), strontium-90 (Sr-90) (⁹⁰Sr), cesium-137 (Cs-137) (¹³⁷Cs), cobalt-60 (Co-60) (⁶⁰Co), and barium-133 (Ba-133) (¹³³Ba), tritium (H-3), ruthenium-106 (Ru-106), californium-252 (Cf-252), krypton-85 (Kr-85), curium-244 (Cm-244) (²⁴⁴Cm), cadmium-109 (Cd-109) (¹⁰⁹Cd), iron-55 (Fe-55) (⁵⁵Fe), promethium-147 (Pm-147) (¹⁴⁷Pm), thallium-204 (Tl-204) (²⁰⁴Tl), antimony-125 (Sb-125) (¹²⁵Sb), plutonium-241 (Pu-241) (²⁴¹Pu), selenium-75 (Se-75) (⁷⁵Se), iridium-192 (Ir-192) (¹⁹²Ir), copper-64 (Cu-64) (⁶⁴Cu), samarium-153 (Sm-153) (¹⁵³Sm), sulfur-35 (S-35) (³⁵S), iridium-194 (Ir-194) (¹⁹⁴Ir), fluorine-18 (F-18) (¹⁸F), potassium bromide (K-42 and Br-82) (⁴²K and ⁸²Br), technetium-99m (Tc-99m) (^{99m}Tc), gallium-68 (Ga-68) (⁶⁸Ga), thallium-201 (Tl-201) (²⁰¹Tl), iodine-123 (I-123) (¹²³I), indium-111 (In-111) (¹¹¹In), yttrium-90 (Y-90) (⁹⁰Y), iodine-131 (I-131) (¹³¹I), cerium-144 (Ce-144) (¹⁴⁴Ce), rhenium-186 (Re-186) (¹⁸⁶Re), rhenium-188 (Re-188) (¹⁸⁸Re), xenon-133 (Xe-133) (¹³³Xe), phosphorus-32 (P-32) (³²P), strontium-89 (Sr-89) (89Sr), and radium-223 (Ra-223) (²²³Ra).

3. The method of claim 1, wherein providing a printing material comprising one or more isotope fragments distributed in a substrate material comprises providing the one or more isotope fragments embedded in a matrix material comprising glass, the one or more isotope fragments embedded in the matrix material distributed in the substrate material.

4. The method of claim 1, wherein forming the printing material into a radioactive article comprises:
heating the printing material to form a flowable printing material; and
forming layers of the flowable printing material over a print bed of the additive manufacturing device to form the radioactive article.

5. The method of claim 4, wherein the substrate material comprises one or more of a ceramic material, acrylonitrile butadiene styrene (ABS), polyethylene terephthalate glycol (PETG), thermoplastic polyurethane (TPU), thermoplastic elastomer (TPE), nylon, acrylonitrile styrene acrylate (ASA), polyvinyl butyral (PVB), high impact polystyrene (HIPS), polyvinyl alcohol (PVA), polycarbonate (PC), polyetherimide (PEI), polyether ether ketone (PEEK), polyetherketoneketone (PEKK), polyvinylidene fluoride (PVDF), polyphenylsulfone (PPSU), and polylactic acid (PLA).

6. The method of claim 1, wherein forming the printing material into a radioactive article comprises:
forming layers of the printing material over a print bed of the additive manufacturing device; and
heating the printing material to form the radioactive article.

7. The method of claim 6, wherein the substrate material comprises one or more of stainless steel, cobalt, copper, titanium, nylon, glass filled nylon, TPU, tungsten, and polypropylene.

8. The method of claim 1, wherein providing the printing material comprises melt blending, through extrusion compounding, one or more non-embedded particles with a thermoplastic filament to form the printing material comprising the one or more isotope fragments dispersed throughout the thermoplastic filament.

9. A method of forming a radioactive article, the method comprising:
providing a printing material comprising a reactant material distributed in a substrate material;
forming, using an additive manufacturing device, layers of the printing material to form an unactivated article comprising the reactant material distributed in the substrate material; and
irradiating at least a portion of the unactivated article to convert at least a portion of the reactant material into a radioactive isotope material to form the radioactive article, the radioactive article comprising the radioactive isotope material dispersed in the substrate material.

10. The method of claim 9, wherein the reactant material comprises one or more of europium oxide and europium salt.

11. The method of claim 10, wherein irradiating at least a portion of the unactivated article comprises neutron irradiating at least the portion of the unactivated article to form one or more of europium-152 (Eu-152) and europium-154 (Eu-154).

12. The method of claim 10, wherein irradiating at least a portion of the unactivated article comprises Bremsstrahlung irradiating the portion of the unactivated article or inducing a photonuclear reaction to convert at least a portion of the reactant material into the radioactive isotope material.

13. A radioactive article, comprising:
one or more isotope fragments distributed in a substrate material, the substrate material comprising a thermoplastic polymer, a fused metal powder, a fused polymer powder, or a ceramic material.

14. The radioactive article of claim 13, wherein the one or more isotope fragments comprise one or more of europium-152 (Eu-152) (¹⁵²Eu), europium-154 (Eu-154) (¹⁵⁴Eu), strontium-90 (Sr-90) (⁹⁰Sr), cesium-137 (Cs-137) (¹³⁷Cs), cobalt-60 (Co-60) (⁶⁰Co), and barium-133 (Ba-133) (¹³³Ba), tritium (H-3), ruthenium-106 (Ru-106), californium-252 (Cf-252), krypton-85 (Kr-85), curium-244 (Cm-244) (²⁴⁴Cm), cadmium-109 (Cd-109) (¹⁰⁹Cd), iron-55 (Fe-55) (⁵⁵Fe), promethium-147 (Pm-147) (¹⁴⁷Pm), thallium-204 (Tl-204) (²⁰⁴Tl), antimony-125 (Sb-125) (¹²⁵Sb), plutonium-241 (Pu-241) (²⁴¹Pu), selenium-75 (Se-75) (⁷⁵Se), iridium-192 (Ir-192) (¹⁹²Ir), copper-64 (Cu-64) (⁶⁴Cu), samarium-153 (Sm-153) (¹⁵³Sm), sulfur-35 (S-35) (³⁵S), iridium-194 (Ir-194) (¹⁹⁴Ir), fluorine-18 (F-18) (¹⁸F), potassium bromide (K-42 and Br-82) (⁴²K and ⁸²Br), technetium-99m (Tc-99m) (^{99m}Tc), gallium-68 (Ga-68) (⁶⁸Ga), thallium-201 (Tl-201) (²⁰¹Tl), iodine-123 (I-123) (¹²³I), indium-111 (In-111) (¹¹¹In), yttrium-90 (Y-90) (⁹⁰Y), iodine-131 (I-131) (¹³¹I), cerium-144 (Ce-144) (¹⁴⁴Ce), rhenium-186 (Re-186) (¹⁸⁶Re), rhenium-188 (Re-188) (¹⁸⁸Re), xenon-133 (Xe-133) (¹³³Xe), phosphorus-32 (P-32) (³²P), strontium-89 (Sr-89) (⁸⁹Sr), and radium-223 (Ra-223) (²²³Ra).

15. The radioactive article of claim 14, wherein the one or more isotope fragments are embedded in a matrix material comprising glass.

16. The radioactive article of claim 13, wherein the substrate material comprises one or more of a ceramic material, acrylonitrile butadiene styrene (ABS), polyethylene terephthalate glycol (PETG), thermoplastic polyurethane (TPU), thermoplastic elastomer (TPE), nylon, acrylonitrile styrene acrylate (ASA), polyvinyl butyral (PVB), high impact polystyrene (HIPS), polyvinyl alcohol (PVA), polycarbonate (PC), polyetherimide (PEI), polyether ether ketone (PEEK), polyetherketoneketone (PEKK), polyvinylidene fluoride (PVDF), polyphenylsulfone (PPSU), and polylactic acid (PLA).

17. The radioactive article of claim 13, wherein the substrate material comprises one or more of stainless steel, cobalt, copper, titanium, nylon, glass filled nylon, TPU, tungsten, and polypropylene.

18. The radioactive article of claim 13, wherein the radioactive article is configured to be reusable.

19. The radioactive article of claim 13, wherein the one or more isotope fragments are encapsulated within the substrate material.

20. The radioactive article of claim 13, wherein the one or more isotope fragments are distributed in a gradient throughout the radioactive article.
